(19) United States
(12) Patent Application Publication
(10) Pub. No.: US 2015/0363816 A1
(43) Pub. Date: Dec. 17, 2015

(54) LOCATION BASED DISCOUNT SYSTEM AND METHOD

(71) Applicant: Shaun Poglitsch, Newington, CT (US)

(72) Inventor: Shaun Poglitsch, Newington, CT (US)

(21) Appl. No.: 14/579,818

(22) Filed: Dec. 22, 2014

Related U.S. Application Data
(60) Provisional application No. 61/919,245, filed on Dec. 20, 2013.

(51) Int. Cl. G06Q 30/02; H04W 4/02

(52) U.S. Cl. CPC G06Q 30/0235; H04W 4/02

(57) ABSTRACT

An apparatus and method of delivering discounts and/or promotions to a consumer based on the presence of the consumer at a physical location.

### CROSS-REFERENCE TO RELATED APPLICATION

This patent application claims benefit under 35 U.S.C. §119(e) to U.S. Provisional Patent Application No. 61/919,245, filed Dec. 20, 2013, which is incorporated herein by reference in its entirety.

### FIELD OF THE INVENTION

The present invention relates to systems and methods utilizing a computer application to provide a consumer a discount toward the purchase of goods and/or services or other promotion based on the location of the consumer.

### BACKGROUND INFORMATION

Consumers are 70% more likely to buy goods and services when in a physical location of a store than if shopping online. In-store shopping provides a hands-on exposure to products and an in-person customer service experience for help with goods, questions, returns, and other aspects of selling goods and services. However, surveys show a majority of consumers prefer to shop online. In an effort to bring consumers into a store, merchants use a variety of methods and incentives. For example, businesses utilize promotions, such as coupons and sales, which may be advertised in flyers, on television, on the radio, on the interne, or by other means.

Some coupons, sales, and incentives are advertised to a consumer when the consumer enters a store, such as by postings in and/or throughout a store that indicate specific sales on specific items. A flyer may be available in the store, or a billboard or other display may indicate, at the storefront and/or throughout the store, that a sale is on going. However, these types of advertising have limited reach and potential pull to bring consumers into a store. They also require the customer to have already entered into the store, or be in visual proximity to the store to see signs or postings on the exterior of the store. Further, these types of advertisements or incentives are limited in that they can often be matched and/or competed with by online retailers.

### SUMMARY OF THE INVENTION

The present invention provides systems and methods utilizing a computer application to provide a consumer a discount toward the purchase of goods and/or services based on the location of the consumer. Embodiments of the present invention provide additional incentives to consumers to encourage them to enter stores and make in-store purchases.

A mobile application, in accordance with embodiments of the present invention, provides consumers with a form of acquiring store promotions. Consumers are able to receive, for example, a random daily promotion that is issued from a predetermined list of offered promotions. Businesses offering the promotions have the ability to set the frequency of distribution for each promotion they are offering. To receive the daily promotion, the consumer enters one of the business's physical locations and receives a notification from the mobile application, via a short-range wireless signal, on their mobile phone. In some embodiments, consumers are only be able to receive one promotion per participating business, per business-day, regardless of how many of a business's physical locations are visited in a single business day.

In some embodiments, when the consumer first acquires the mobile application, such as by download, a screen will prompt the consumer to input information, including for example, birth year, gender, and ethnicity from a predetermined list. This data is used to provide demographic information back to each participating business for each promotion issued per store as well as purchases associated with the issuance of promotion through the mobile application.

The location of the consumer, in the physical location of the store, may be determined by any known means, including one or more of the following: GPS; cellular/mobile data network location (e.g., cell tower location); Bluetooth, WiFi or other connection to a remote computer or device at or near the actual location of the consumer; consumer input; Barcode or QR code at the physical location, scanned or imaged by a computerized device either containing or in data connection with the mobile application, where the Barcode or QR code can either itself contain information regarding the physical location or contain instruction or information used by the mobile application to retrieve the location information from a file or remote computer.

The mobile application presents promotions or discounts to the consumer on the mobile device. The promotion may be in the form a coupon or discount code delivered to the mobile application that may be used by the consumer upon purchase of goods and/or services (including by scanning or inputting code by the seller). The discount may be for good and/or services at the particular location of the consumer, e.g., the store near or in which the consumer is located, or for some other location. The provision or delivery of the promotion to the consumer may be based upon the physical location of the consumer.

In addition to coupons and discount codes, in some embodiments, the promotion may also be in the form of a credit on an account of the consumer that can be used with the consumer's purchase. This can include an account with the seller, or some other account from which the consumer would make the purchase—credit card, debit card, bank account, PayPal, gift card, etc.

In some embodiments, the promotion may be limited in time (e.g., usable only a selected number of hours or for the specific day the promotion is delivered), limited in geographical scope (e.g., can only be used in particular locations or stores, or may expire or terminate if the consumer leaves a designated area or location), limited in frequency (e.g., the consumer can obtain only one per day or week), or conditional upon what the consumer purchases (e.g., amount purchased, particular types of goods/services purchased, etc.).

In some embodiments, the discount provided may be a randomly-selected discount, based on various criteria, or both. The criteria can include, for example (aside from location), the demographic profile of the consumer (which may be input/stored in the mobile application or at a remote computer database with which the mobile application communicates), demographic profile(s) and location(s) of other consumers, current promotions/sales/incentives of the seller, previous activity of the consumer (e.g., previous visits to the location, previous purchases, frequency of visits to the location, frequency of purchases at the location, visits and/or purchases from competitors, etc.). The mobile application may also collect information about the consumer's current visit to that location (e.g., length of total visit or time at sublocations—particular departments of the store or stores in a mall, purchases made during visit) that can be determined by monitoring the location of the consumer during the visit, whether a promotion is utilized or not, visits to competitors (e.g., by monitoring the consumer's location, returning to previous locations, etc.) for current or future storage and use in determining a promotion to provide to the specific consumer.

The promotion may be provided to the consumer in the mobile application automatically when (or shortly after) the consumer arrives at the physical location, or upon request of the consumer.

Other objects and advantages of the present invention will become apparent in view of the following detailed description of the embodiments and the accompanying drawings.

### BRIEF DESCRIPTION OF THE DRAWINGS

FIG. 1 is a schematic of an exemplary store for employing embodiments of the invention.

FIG. 2 is a schematic of a displayed screen showing a promotion notification.

FIG. 3 is a schematic of a displayed screen showing a promotion.

FIG. 4 is a schematic of a shopping area where embodiments of the invention can be employed.

FIG. 5A is a schematic of a displayed screen showing a populated listing screen.

FIG. 5B is a schematic of a displayed screen showing a first exemplary promotion.

FIG. 5C is a schematic of a displayed screen showing a second exemplary promotion provided.

FIG. 5D is a schematic of a displayed screen showing a third exemplary promotion.

FIG. 5E is a schematic of a displayed screen showing a fourth exemplary promotion.

### DETAILED DESCRIPTION OF EMBODIMENTS OF THE INVENTION

A computer application, such as a mobile application, and accompanying computerized system provides merchants with a means to provide, and consumers to receive, in-store promotions when the consumer enters into or in proximity of a store. Consumers may receive, for example, a promotion that is issued from the merchant selected from a predetermined list of promotions offered by the merchant on a consumer's mobile device. The mobile application of the consumer interacts with a computerized system used by the merchant to deliver the promotion. This may be done wirelessly between the consumer's mobile device (e.g., a mobile phone, tablet or other computerized device) and the merchant's computerized system. The wireless communication may be by any currently known or later known manner for wirelessly communication between the mobile application and merchant system. However, the invention is not limited to wireless communication, and contemplates communication by any manner, method or means, currently known and later-known.

The promotion delivery system cooperates and interacts with the consumer's mobile application so that a merchant or business offering a promotion has the ability to provide the consumer with one or more the specific offerings available. When the consumer enters into or in proximity to a store, a notification may be delivered to the consumer through the mobile application on the consumer's mobile device. The notification can provide an alert that a promotion is available.

The consumer can acquire the mobile application by download or other installation method to a consumer's mobile device, as is known or later becomes known. The consumer's device may be a cellular or mobile phone, smart phone, digital music player, electronic tablet, laptop, PDA, or other portable consumer electronic device. These devices may include location identifiers, either internal or external, internet connection capabilities, or other types of information or means for determining physical location. The location of the consumer may be determined by any known or later-known manner, method or means, including one or more of the following: GPS; cellular/mobile data network location (e.g., cell tower location); Bluetooth, WiFi or other connection to a remote computer or device at or near the actual location of the consumer; manual consumer input; Barcode or QR code at the physical location, scanned or imaged by the consumer's mobile device either containing or in data connection with the mobile application, where the Barcode or QR code can either itself contain information regarding the physical location or contain instruction or information used by the computer application to retrieve the location information from a file or remote computer.

Once the merchant system determines that the consumer's device, and hence, the consumer, is located in or in proximity to the merchant store or business, the merchant system can deliver a promotion to the consumer through the communication connection with consumer's mobile device and installed application. This can be done, for example, through an internet connection, Bluetooth, WiFi, infrared or other connection and protocol. The invention is not limited to any particular type of communication means and protocols.

The consumer has the ability to create a consumer profile within the mobile application. When the application is opened, a screen will prompt the consumer to input information specific to the consumer and to create the consumer profile. The consumer profile may include the consumer's location (such as home town), age, birth date or year, gender, ethnicity, purchasing preferences, preferred shopping locations, etc., which may be prompted from one or more predetermined lists within the mobile application. The consumer profile is stored within the application (on the consumer's device) and/or may be transmitted to and stored on remote servers associated with the mobile application, e.g., cloud-based. The profile may be transmitted to merchant system, which can utilize the profile information. For example, the merchant system may use the profile information to determine which promotion(s) or subset of promotions the merchant to offer to the consumer. By way of example only, the gender of the consumer may be used to select a promotion or subset of promotions to offer to the consumer considered by the merchant to be desirable for or more likely to be utilized by a consumer of that gender. As another example, the profile information may be used to create demographic profiles of customer bases who visit the store.

Once set-up, the consumer can then use the mobile application to receive promotions from participating merchants. A participating merchant may post a notification in or at the store, or other location, indicating that they participate in the promotion delivery system. Further, merchants can advertise that various random promotions will be available to consumers that use the mobile application, such as by sending mailings, emails, postings in newspapers, etc.

The merchant can create a set or sets of promotions that will be delivered to consumers when they enter the physical location of or proximity of the store or business and the mobile application is running. As described below, the promotion may include discounts, credits, or other types of coupons and/or promotions that will incentivize a consumer to purchase goods or services in the store. For example, the promotion list may include promotions for 5% off, 10% off, 15% off, a free product or service, $5.00 voucher, $10.00 voucher, etc. The promotion list may be a single promotion that will be delivered to all consumers, i.e., every consumer will receive the same promotion, e.g., all consumers receive a 10% off promotion. Alternatively, the promotion list may include a number of different promotions from which one or more may be selected to be delivered to consumer that uses the mobile application. For example, a first consumer may use the mobile application and receive a 10% off coupon, and a second consumer may receive a $5.00 voucher, etc.

The merchant can determine how a promotion is selected to be delivered to a consumer entering the store. For example, the selected promotion may be the next in the list, such that the program rotates through the list of promotions. Alternatively, the promotion may be selected and provided randomly by the merchant from a list of available promotions. The random nature of a promotion can incentivize a customer to visit a store because the nature of the promotion is unknown. In contrast, where the promotion is known prior to a consumer's visit to the store or business, such by advertising or direct marketing to the consumer (e.g., an e-mail), the consumer may determine that the promotion incentive is not sufficient to cause the consumer to travel to the business. Where the promotion is unknown, consumers may travel to the store to learn what the promotion is. Once at the store, the consumer is more likely to patronize the business and purchase goods/services. In addition, the random and/or unknown nature of the promotion can generate excitement and anticipation in consumers, similar to the way the lottery or other games of chance interest consumers.

In addition, the merchant may use, at least in part, selected or desired information to select and provide a promotion to the consumer. Such information could include demographic information in the consumer's profile, e.g., gender, age categories and/or ranges, hobbies, occupation, family status, etc. For example, for a female consumer, the merchant system may provide promotion(s) that would be of interest to female consumers. Any information in the profile of the consumer may be utilized, and various items of information can be combined. By way of example, the promotions can be provided based on a combination of gender and age. One or more profile attributes can be weighted relative to each other to determine which promotion or subset of promotions may be provided to the consumer.

The promotion provided may also be based, in whole, in part, or in combination with other criteria (including but not limited to criteria discussed herein), based on the consumer's history. Non-limiting examples include the previous activity of the consumer, including but not limited to previous visits to this merchant, previous purchases at this merchant, frequency of visits and/or purchases with this merchant, visits to and/or purchases from competitors, etc.

On the other hand, the utilized information may be unrelated to the consumer's profile or history. As examples, such information could include the date, time of day, sales history of the store over a given period, e.g., the day the consumer is in the store, current promotions/sales/incentives of the merchant, proximity to a particular location or sublocation within the store, which may provide a promotion for a product located at or near that location/sublocation, or at another location in the store to incentivize the customer to travel to that other location, sales or coupons offered by competitors, etc. Accordingly, the merchant system can tailor the promotion delivery based on criteria aside from or independent from the consumer and the consumer's current general location (e.g., somewhere in the store). In this manner, that the merchant can present specific promotions at a time when they are most likely to increase the possibility of a sale to a consumer, or assist the merchant in meeting sales goals, e.g., revenue, type of item, etc.

In addition to the specific promotions, the merchant can impose limitations and other criteria related to the promotion. For example, the merchant can enter a time period when promotion(s) will be available, limitations on time of use (e.g., the calendar day, or that the promotion will expire when the consumer leaves the store), limited in geographical scope, beyond which limit, e.g., relative to the physical location of the store, the promotion is deactivated and can no longer be used (e.g., can only be used in particular locations or stores), or may expire or terminate if the consumer leaves the store, a designated area, or a designated location), limited in frequency (e.g., the consumer can obtain only one per specific time period, such as per day or week), conditional upon what the consumer purchases (e.g., based on the amount purchased, particular types of goods/services purchased, etc.), and/or comments that provide terms/limitations regarding use, combinations with other promotions, etc.

The invention is not limited to utilizing any particular type of information or limitations, but may utilize any information or limitations desired or considered beneficial to the merchant. Moreover, the merchant may utilize and combine different types or information or limitations to provide promotions, yet maintain a random or semi-random promotion system. The merchant may designate or the merchant system can generate a subset of promotions that are subsequently randomly selected from based on specific criteria, such as gender, age categories and/or ranges, etc. For example, for the above-discussed female consumer, the merchant system may randomly select from a subset of promotions that the merchant considers would interest a female consumer. It should be recognized further that the subsets can be determined by any one or combination of criteria for selecting promotions, such as discussed above. In this manner, the merchant can tailor the promotions to the specific needs of the business and/or customer base. At the same time, the merchant can maintain a desired degree of randomness of the promotions to achieve the benefits of a randomness, e.g., as discussed above.

Advantageously, the invention permits merchants can tailor the promotions however they think would be most effective fit. For example, if a business wants to promote a specific item on a specific day, the promotion that is presented to consumers entering the store may apply only to that specific item during the specific visit of the consumer. This encourages the consumer to purchase the item immediately, and from the particular location or store that presents the promotion. Alternatively, a promotion may apply to an entire purchase by the consumer, or a portion thereof. For example, the promotion may apply to a specific category of products, such as cosmetics, home goods, clothing, electronics, etc. This is particularly useful in department stores or in stores with a variety of types of goods or services.

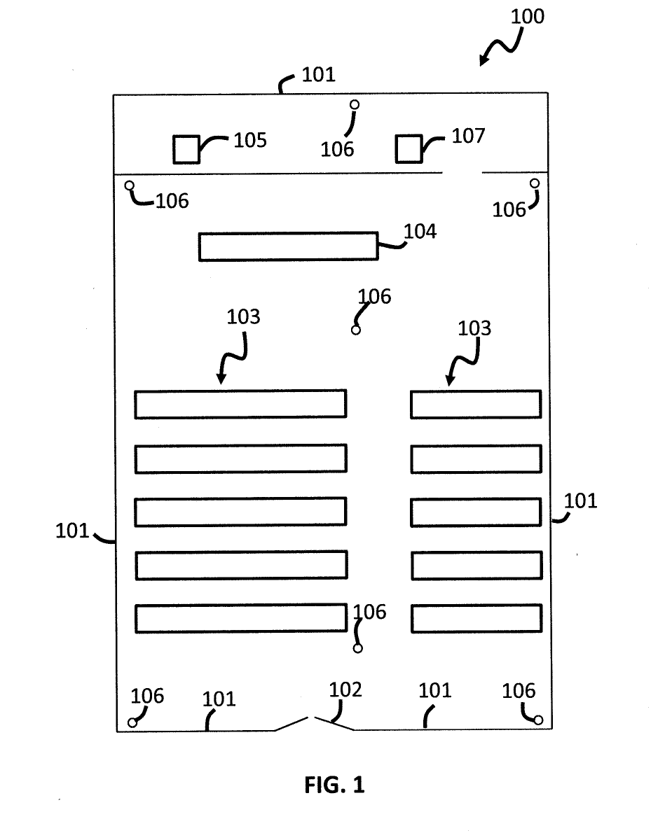

Turning now to FIG. 1, an exemplary store employing embodiments of a promotion delivery system is shown. Store 100 defines a physical space with walls 101 and an entry door 102. Goods are displayed for purchase on shelving 103. The store 100 has a check-out or purchase area 104 with registers for ringing up or otherwise executing consumer purchases in the store 100. In this embodiment, the store 100 also includes a router 105 or other internet wireless communication device that is used to establish a communication connection to consumers' mobile devices when they enter or come in proximity to the store. The communication is broadcast at one or more access points 106 so that a desired portion of (e.g., the entire) store is provided with wireless communication with the customer. In one embodiment, the communication system 105/106 provides a Wi-Fi communication system. However, any suitable wireless communication system may be used.

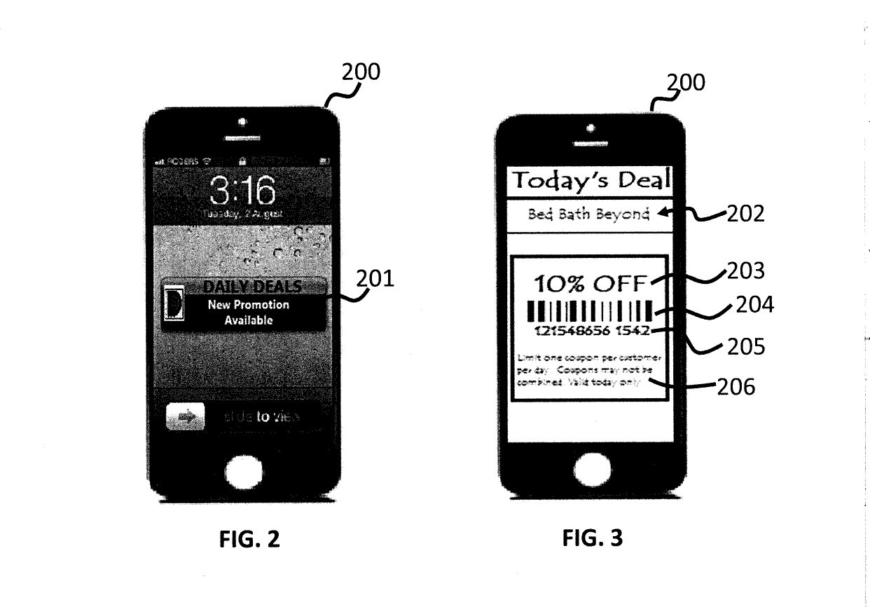

The merchant system includes a computer system 107. The computer system 107 includes programmable software and internet or other communication capability. The computer system 107 executes one or software programs to implement the promotion delivery system. The merchant can use the computer system 107 and associated software to generate a list of promotions and related limitations and criteria and program the system 107 to deliver promotions to consumers that enter into or proximity to the store. For example, if a consumer enters the store and connects to the store's wireless communication system via an access point 106, the system will recognize that a new device or consumer has connected to the store's network. The system will then deliver a notification to the consumer's device regarding an available promotion or promotions (see FIG. 2). After the consumer receives the notification, the consumer may access the promotion using the mobile application (see FIG. 3) and use it at the time of purchase. The store will ring up the consumers purchase utilizing the promotion in a manner similar to known promotions such as coupons. For example, as shown in FIG. 3 (and discussed further below), the promotion includes a bar code that the sales agent can scan to apply the promotion to the consumer's purchase. It should be understood, however, that the manner by which the sales agent or business applies the promotion is not limited to any particular form, but can include any manner of applying the promotion. For example, alternative to a bar code, the promotion can include a QR code, an alphanumeric code that the agent enters into the sales system, or a manually entered discount applied by the sales agent.

In the embodiment of FIG. 1, the computer system 107 is located with the store 100. However, the system 107 may be located at another location as desired by the merchant. It may be also be located in part in the store 100 and in part at another location. In some embodiments, where the merchant has multiple stores or location, the system 107 may be located in a “centralized” location and service one or more stores. In yet other embodiments, the system 107 may provide service to more than one merchant. In certain embodiments, the system 107 may not be self-contained by utilize dispersed computerized services, e.g., the cloud. In the above such embodiments, the router 105 may further contain a modem for internet connection with remote parts of the computer system 107. In other embodiments, the modem is separate from the router, and in communication or placeable in communication with the router or directly indirectly with the access points 106.

In some embodiments, before or when delivering a promotion, the merchant's system may also request and/or automatically receive information from the consumer's device, such as the consumer's profile or portions thereof. Advantageously, the demographic information and other user information provided in the consumer profile may be transmitted to the merchant for data collection and/or other uses. Alternatively, the profile may be transmitted to the merchant prior to the consumer entering the store, e.g., upon initial activation of the mobile application, stored on the computer system 107 or otherwise be accessible to the computer system 107 (e.g., in the cloud), for access and use by the computer system 107 when the consumer enters the store. Accordingly, the merchant can utilize the consumer's identification (e.g., upon entering the store) and can track purchases associated with issuance of a promotion and/or other criteria related to the merchant's consumer base. This enables a merchant to tailor promotions based on location or other variables associated with consumers, and also can allow merchants to track usage of promotions, both on an individual consumer basis and to consumers sharing one or more characteristics with that user (e.g., demographic information). The tracking enables merchants to further tailor their promotions to their customer base and/or tailor their promotions to bring in new customers.

As noted above, the invention may utilize any means to determine that a consumer is physically present in the store. For example, in some embodiments, Bluetooth connections may be used instead of Wi-Fi network, which have a limited range and thus can desirably limit the area for promotion delivery. When using a Bluetooth connection, a similar process is followed in that the consumer will connect with a network or device provided by and/or located in the store. Referring to FIG. 1, instead of access points 106 providing, for example, a Wi-Fi internet connection, access points 106 may provide Bluetooth access points.

Alternatively still, delivery of promotions may be based on the presence of a wireless connection between the consumer's device and devices at the store's location. The physical presence of a consumer in the store may be determined by GPS location data determined by a GPS feature of the consumer's device. The mobile application on the consumer's device will recognize its location based on the GPS data. With this information, a promotion may be delivered from a server that is employed by the store, but rather than directly delivered from an access point in the store using the consumer data connection, delivered by a third-party connection, such as a cellular data network. In such embodiments, for example, the listing of promotions and other information entered by the merchant may be completed in a web-based application, or entered into a program and then uploaded to a server. When using a GPS-based system, the promotion delivery is substantially similar to that described above, by placing a promotion to a consumer based on the consumer's physical location.

Alternatively, the merchant can provide a physical, in-store, means for determining the physical presence of a consumer. In this embodiment, the merchant can provide a barcode or QR code or other scannable media that the consumer scans when using the mobile application. In a similar fashion, the merchant can provide an alphanumeric code presented at the store that the consumer can enter into the mobile application to receive a promotion. The alphanumeric code can be unique to the individual store of a merchant having multiple stores, so that the merchant system can identify which store the consumer is visiting and/or the promotion can differ depending on which of the merchant's stores the consumer visits.

Alternatively still, the consumer can possess a personal identification device that is detected by equipment in the store to alert the promotion system that the user is present. One such example is an RFID device. Another example is a card or other document held by the user containing a unique identification of the customer. The card can contain, for example, a bar code or QR code that is read by a scanner at the store. Yet further, the consumer may be provided a unique identification number that the user enters into a device at the store, e.g., a username, password, PIN, etc. The promotion can then, for example, be transmitted to the user's mobile device, e.g., via a short-range communication system. Such embodiments could permit, for example, a promotion system that does not require an expansive in-store communication system, e.g. WiFi, in order to recognize the presence of a customer.

Those skilled in the art will appreciate that these are merely examples of determining the presence of the consumer in the store and delivery of promotions thereto and other means and methods may be used without departing from the scope of this invention.

Turning now to FIGS. 2 and 3, exemplary schematics of the consumer mobile application are shown on a consumer's mobile device 200. Once the application is activated and a consumer profile is established, the consumer can enjoy the benefits of being provided real-time, in-store, promotions. To receive one or more promotions from merchants, the consumer merely enters a store location or area, such as shown in FIG. 1, and is provided with a notification that a promotion is available. The notification 201 will be displayed on the device when the consumer enters the physical location of the store, as discussed above, based on a connection to a store's network, connection to a device in-store, by GPS location information, by the consumer scanning a barcode or other code to identify the consumer's location, etc. In some embodiments, the promotion may be provided to the consumer on the application automatically when (or shortly after) the consumer arrives at the physical location. In alternative embodiments the promotion may only appear upon request of the consumer, such as by opening the mobile application when in the store or by “requesting” a promotion within the application. The notification 201, as shown, indicates that there is a “New Promotion Available” as a “Daily Deal.” The consumer can then open the application to view the promotion 202, shown in FIG. 3. Upon receiving the promotion 202, the consumer may then browse the store, and make a purchase using the promotion delivered to their mobile device 200. In this way, the consumer can save money, receive the benefits of in-store purchases, including in-person customer service, and the business can obtain more sales and/or customers.

In FIG. 3, the application is shown with a promotion 202 displayed, for example, to Bed Bath & Beyond, the store of the consumer's current location, which may be a store as described in FIG. 1. As shown in FIG. 3, the promotion 202 is in the form of a discount or deal 203, such as a coupon or code, delivered to the consumer's mobile device 200. Promotion 202 includes a barcode 204 and associated code number 205 for this particular promotion. Below the barcode 204 and number 205 of promotion 202, limitations and/or terms 206 are included. The promotion may also be in the form of a credit on a personal store account of the consumer that can be used with the consumer's purchase, such as with a business's loyalty program or store credit card. Further, credits or similar promotions can include credits to an account with the business, or some other account from which the consumer could make a purchase—credit card, debit card, bank account, PayPal, gift card, etc. In the latter example, the consumer can input their financial information related to the account(s) into the consumer profile so that the credit is automatically applied through the mobile application.

The consumer can then present the promotion 20 on the consumer's device 200 to the cashier or sales agent at the time of checking out, to receive the promotion. In some embodiments, the merchant may collect information from the consumer profile, as described above, at the time the promotion is redeemed. Further, the merchant may add information regarding the purchase a database it maintains regarding the consumer, for informational purposes or for future use to provide the consumer with promotion(s), e.g., whether or not a provided promotion was used, items purchases, price of the purchase, type of payment used (cash, credit card, debit card, gift card, etc.).

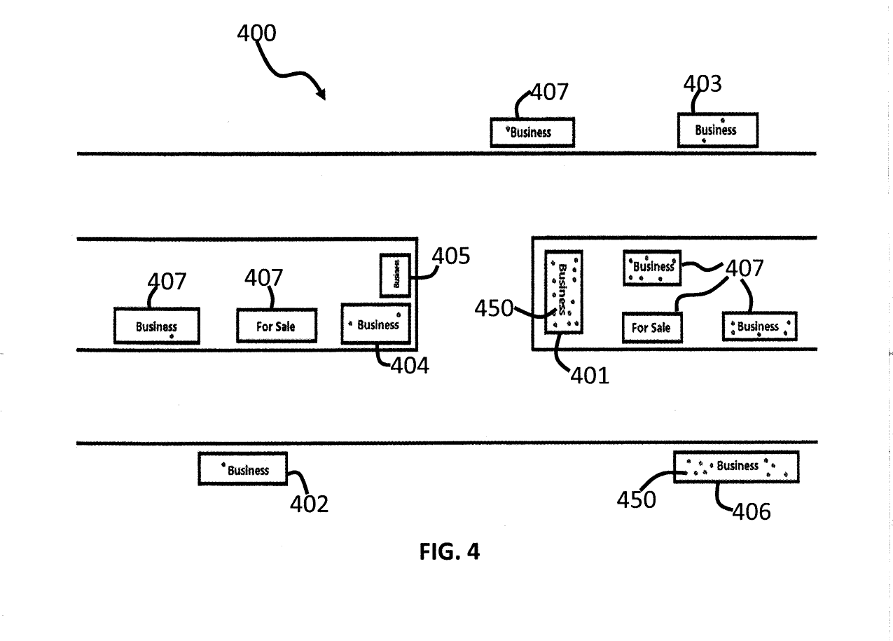

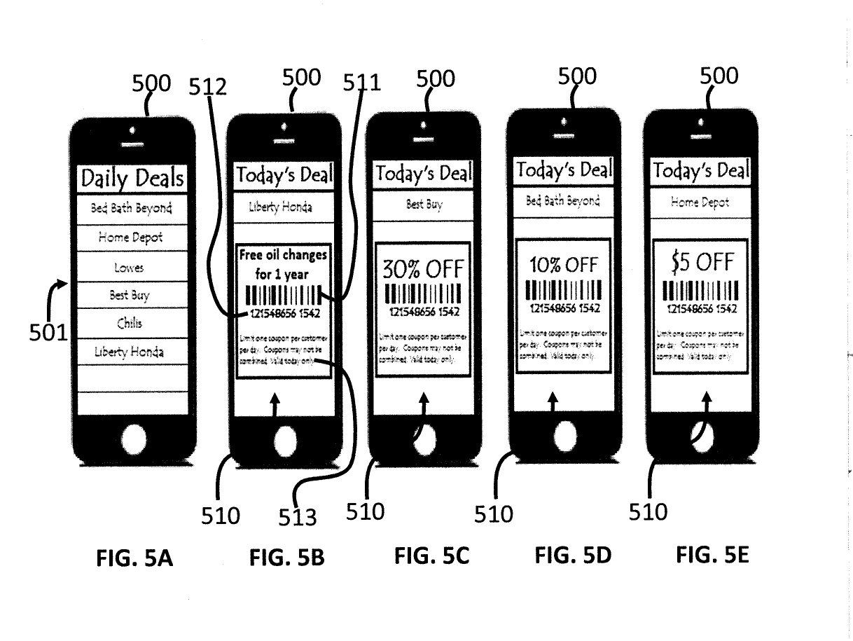

In an alternative embodiment, shown in FIGS. 4 and 5A-5E, the consumer may enter a shopping area or plaza 400 with a number of merchants (401-407), some of which may participate in the promotion delivery program associated with the consumer's mobile application (401-406), and others that may not, shown as businesses 407. Upon opening the application on the consumer device 500 (FIGS. 5A-5E), and having a connection to the Internet or other wireless communication connection and based on location information of the consumer, the mobile application may be populated with a list of merchants 501, as shown in FIG. 5A. In this example, the shopping plaza may include various merchants, such as Bed Bath & Beyond 401, Home Depot 402, Lowes 403, Best Buy 404, Chili's 405, and Liberty Honda 406, which all participate in the promotion delivery program. These merchants represent shopping stores, restaurants, and a car dealership, but any merchant and/or type of merchant that provides goods and/or services can participate in the promotion delivery system described herein. The consumer can then select one of the merchants from the list 501 shown in FIG. 5A, and the promotion of the particular merchant may be displayed, as shown in FIGS. 5B-5E.

With reference to FIG. 5B, the promotion 510 offered by Liberty Honda 406 is shown as “Free oil changes for 1 year.” Promotion 510 includes a barcode 511 and associated code number 512 for this particular promotion. Below the barcode 511 and number 512 of promotion 510, limitations and/or terms 513 are included. For example, limitations on combinations, duration of promotion (as shown, for that day only), number of promotions that may be used, or, for example, validity only with the purchase of a new and/or used car, may be displayed. In FIGS. 5C and 5D, the promotion 520 of Best Buy 404 and the promotion 530 of Bed Bath & Beyond 401 are shown, respectively, which indicate a percentage off of the consumer's total purchase. Finally, in FIG. 5E the promotion 540 for Home Depot 402 is shown as a dollar amount that is available to the consumer.

In some embodiments of the embodiment described with respect to FIGS. 5A-5E, a consumer may only be able to select a single promotion (510, 520, 530, or 540) for the day from the list 501 provided. As such, a consumer may be prompted with the locations and/or participating merchants, such as shown in FIG. 5A, and the consumer may then select the particular merchant from which they would like to receive a promotion. In this scenario, the mobile application will then delete and/or remove the other options available from list 501. This procedure encourages consumers to select the store they will most likely shop at, and provides an incentive for the consumer to shop in-store with that particular merchant.

In a further embodiment, rather than providing the entire listing 501 of merchants when a consumer enters the plaza, each of the above deals shown in FIGS. 5B-5E may be presented to a consumer only when they enter the particular location of the specific merchant, as described above with respect to FIGS. 1-3. For example, the Best Buy promotion will only be displayed to the consumer if the consumer physically enters the Best Buy store.

Advantageously, a merchant may place a promotion to a consumer to further encourage the consumer to purchase at the store. The merchant can operate a computer system that is configured to push the notifications and promotions to consumers when they enter the store or selected area. In alternative embodiments the merchant may place sign or other display means with a scannable code, or a code that a consumer can input into their device, to receive the promotion(s). Then, when a consumer presents the promotion to a cashier on their mobile device, the cashier can scan a barcode or QR code or other type of readable code that is displayed on the screen or input a written code that is displayed on a screen, such as an alphanumeric code. This will enter the promotion onto the consumer's purchase order and apply the promotion, such as a discount, to the order as appropriate.

In some embodiments, consumers may be able to receive only one promotion per participating business or merchant, per business-day, regardless of how many of a merchant's physical locations are visited in a single business day. Advantageously, this encourages the consumer to enter a store and use the current promotion while in-store, and discourages the consumer from visiting a different store of the merchant in hopes of receiving a different and “better” promotion. Further, in some embodiments, the promotion may expire upon leaving the physical location of the store, thus further encouraging consumers to shop and purchase in the store they enter, without shopping around with other merchants, such as competitors.

Further, advantageously, the application may also collect information about the consumer and/or the consumer's current visit to a particular merchant, including length of total visit or time at sub-locations within the store (e.g., particular departments of store or stores in a mall), purchases made during a visit, whether the promotion is utilized or not, information regarding visits to competitors based on information provided by the consumer's profile, the consumer returning to previous locations, etc. As seen in FIG. 4, the locations of consumers 450 participating in the promotion system and present in the shopping area 400 are shown. The collected information may be stored on the consumer's device (or on the cloud) and associated with the consumer profile, such that it can be provided to each merchant visited, and/or may be stored with the particular merchant and/or group of merchants. For example, the location of the consumer as determined by the mobile device's GPS may be stored on the mobile device in the application, and then transmitted to a merchant once the consumer enters that merchant's stores. Once obtained, the information can be utilized by the merchant for the current visit of the consumer and/or may be stored with the merchant's customer database and associated information for one or multiple consumer profiles. In such manner, the merchant system can track the locations of the participating consumers, and in some embodiments, in connection with the profiles and other information for those consumers, utilize such information to present promotions. By way of example, if the customer visited Liberty Honda 406 and then visits Best Buy 404, the Best Buy 404 merchant can present promotions to the customer related to automotive electronics.

In addition, in some embodiments, the different participating businesses 401-406 may share consumer purchase information with each other, so that merchants can deliver promotions to the consumer based on purchases at other merchants. By way of example only, if a customer purchases a picture frame at Bed Bath Beyond 401, and the customer then visits Home Depot 402, the merchant system can present promotions to the customer for picture hanging hardware.

Advantageously, as described, in some embodiments, multiple merchants can use the same system, such as in a mall, strip-mall, or other grouping of stores 400. In such embodiments, the system can track multiple consumers and collect information regarding consumer habits, such as number of visits, how long a consumer visits the location(s), how long consumers spend in particular stores at the location, demographics of the consumers that visit the location and the stores, use of the promotions provided through the mobile application, etc. This enables the merchants to tailor the promotions more particularly and enables tracking of how effective the promotions are with consumers.

As may be recognized by those of ordinary skill in the pertinent art based on the teachings herein, numerous changes and modifications may be made to the above-described and other embodiments of the present invention without departing from its scope as defined in the appended claims. In addition, though the invention may be used for personal data collection from a number of wirelessly accessory devices, it should be understood that the invention may be utilized for other applications as well. Accordingly, this detailed description of embodiments is to be taken in an illustrative as opposed to a limiting sense.

What is claimed:

1. A method of delivering promotions to a consumer, comprising:
generating a promotion list comprising at least one promotion on a computer system having a computer application;
determining that a consumer having a mobile device including a mobile application is present in a physical location;
selecting a promotion from the promotion list;
at least one of providing a notification to the mobile application notifying a consumer that a promotion is available and providing the selected promotion to the mobile application; and
wherein at least one of (1) the selecting step comprises randomly selecting a promotion from the promotion list and (2) the promotion expires at least one of (a) at a predetermined time and (b) when the consumer departs from said physical location.

2. A method as defined in claim 1, wherein the step of providing the selected promotion includes transmitting said promotion from the computer system to the mobile application.

3. A method as defined in claim 1, further comprising the computer application receiving information from the mobile application.

4. A method as defined in claim 3, wherein the received information comprises at least a portion of a profile of the consumer.

5. A method as defined in claim 3, further comprising storing said information received by the computer in a database.

6. A method as defined in claim 3, wherein the step of receiving information from the mobile application occurs prior to the step of selecting a promotion, the selecting step further comprising using the received information.

7. A method as defined in claim 1, wherein the physical location is a geographical limit relative to a store.

8. A method as defined in claim 7, wherein the geographical limit is the physical bounds of the store.

9. A method as defined in claim 1, wherein the predetermined time is an end of a calendar day that the selected promotion is provided to the mobile application.

10. A method as defined in claim 1, wherein the determining step comprises at least one of using GPS location data from the mobile device, using cellular data network location data for the mobile device, using a Bluetooth connection between the mobile device and a Bluetooth device in communication with the computer system, using a Wi-Fi connection between the mobile device and a Wi-Fi access point in communication with the computer system, using location identifying information input into the computer system by the consumer, a consumer scanning a barcode at the physical location with the mobile device, and a consumer scanning a QR code at the physical location with the mobile device.

11. A system for delivering promotions to a consumer comprising:
a computer system having a computer application including a promotion list comprising at least one promotion;
means for determining the presence at a physical location of a mobile device of a consumer including a mobile application configured to receive notifications and promotions from the computer application;
a communication connection between the means for determining and the computer system;
means for providing from the computer system to the mobile application at least one of a notification to the mobile application notifying the consumer that a promotion is available and a promotion from the promotion list; and
a communication connection between the means for providing and the computer system;
wherein the computer system and the computer application are configured to, when the mobile device is determined to be at the physical location by the means for determining, select a promotion from the promotion list and, via the means for providing, provide at least one of a notification to the mobile application notifying the consumer that a promotion is available and providing the selected promotion to the mobile application; and
wherein at least one of (1) the computer application is configured to randomly select a promotion from the promotion list and (2) the promotion expires at least one of (a) at a predetermined time and (b) the consumer departs from said physical relation.

12. A system as defined in claim 11, wherein the physical location is one of the bounds of a store and a geographical limit relative to a store.

13. A system as defined in claim 11, wherein the means for providing is configured to transmit said selected promotion to the mobile application.

14. A system as defined in claim 11, wherein the computer application is configured receive information from the mobile application.

15. A system as defined in claim 14, wherein the computer system is configured to store information received from the mobile application in a database.

16. A system as defined in claim 14, wherein computer application is configured to select the promotion from the promotion list using information received from the mobile application.

17. A system as defined in claim 11, wherein the means for determining is configured to use GPS location data from the mobile device, cellular data network location data for the mobile device, a Bluetooth connection between the mobile device and a Bluetooth device in communication with the computer system, a Wi-Fi connection between the mobile device and a Wi-Fi access point in communication with the computer system, location identifying information input to the computer system by the consumer, a barcode at the physical location scanned with the mobile device, and a QR code at the physical location scanned with the mobile device.
